(19) United States
(12) Patent Application Publication
(10) Pub. No.: US 2009/0151564 A1
(43) Pub. Date: Jun. 18, 2009

(54) SYSTEM AND METHOD FOR REMOVAL OF AN ACIDIC COMPONENT FROM A PROCESS STREAM

(75) Inventors: Nareshkumar B. Handagama, Knoxville, TN (US); Rasesh R. Kotdawala, Knoxville, TN (US); Barath Baburao, Knoxville, TN (US); Michael W. Pontbriand, Vonore, TN (US)

Correspondence Address: MICHAUD-DUFFY GROUP LLP, 306 INDUSTRIAL PARK ROAD, SUITE 206, MIDDLETOWN, CT, 06457, US

(73) Assignee: ALSTOM Technology Ltd., Baden (CH)

(21) Appl. No.: 12/269,352

(22) Filed: Nov. 12, 2008

Related U.S. Application Data
(60) Provisional application No. 61/013,376, filed on Dec. 13, 2007.

(51) Int. Cl. B01D 53/14

(52) U.S. Cl. 95/179; 96/242; 96/234

(57) ABSTRACT

A system (10) for absorbing and thereby removing at least a portion of an acidic component from a process stream (20), the system including: an absorber (22) adapted to accept a process stream, wherein the absorber employs an absorbent solution to absorb an acidic component from the process stream to produce a rich absorbent solution (24) and a process stream having a reduced amount of said acidic component (20a); a regenerator (26) adapted to regenerate the rich absorbent solution, thereby producing a lean absorbent solution (28) and a semi-lean absorbent solution (30); a solution outlet (50) fluidly coupled to the regenerator to facilitate removal of at least a portion of the semi-lean absorbent solution from the regenerator; and a control mechanism (56) coupled to the solution outlet, the control mechanism adapted to control an amount of the semi-lean absorbent solution removed from the regenerator.

### CROSS-REFERENCE TO RELATED APPLICATION

This application claims the benefit of U.S. Provisional Patent Application Ser. No. 61/013,376 filed Dec. 13, 2007, which is hereby incorporated by reference in its entirety.

### TECHNICAL FIELD

The disclosed subject matter relates to a system and method for increasing the removal of an acidic component from a process stream. More specifically, the disclosed subject matter relates to a system and method for increasing the removal of an acidic component from a process stream while reducing the amount of energy needed to do so.

### BACKGROUND

Process streams, such as waste streams from coal combustion furnaces, often contain various components that must be removed from the process stream prior to its introduction into an environment. For example, waste streams often contain acidic components, such as carbon dioxide (CO₂) and hydrogen sulfide (H₂S), that must be removed or reduced before the waste stream is exhausted to the environment.

One example of an acidic component found in many types of process streams is carbon dioxide. Carbon dioxide (CO₂) has a large number of uses. For example, carbon dioxide can be used to carbonate beverages, to chill, freeze and package seafood, meat, poultry, baked goods, fruits and vegetables, and to extend the shelf-life of dairy products. Other uses include, but are not limited to treatment of drinking water, use as a pesticide, and an atmosphere additive in greenhouses. Recently, carbon dioxide has been identified as a valuable chemical for enhanced oil recovery where a large quantity of very high pressure carbon dioxide is utilized.

One method of obtaining carbon dioxide is purifying a process stream, such as a waste stream, e.g., a flue gas, in which carbon dioxide is a byproduct of an organic or inorganic chemical process. Typically, the process stream containing a high concentration of carbon dioxide is condensed and purified in multiple stages and then distilled to produce product grade carbon dioxide.

The desire to increase the amount of carbon dioxide removed from a process gas is fueled by the desire to increase amounts of carbon dioxide suitable for the above-mentioned uses (known as “product grade carbon dioxide”) as well as the desire to reduce the amount of carbon dioxide released to the environment upon release of the process gas to the environment. Process plants are under increasing demand to decrease the amount or concentration of carbon dioxide that is present in released process gases. At the same time, process plants are under increasing demand to conserve resources such as time, energy and money. The disclosed subject matter may alleviate one or more of the multiple demands placed on process plants by increasing the amount of carbon dioxide recovered from a process plant while simultaneously decreasing the amount of energy required to remove the carbon dioxide from the process gas.

### SUMMARY

According to aspects illustrated herein, there is provided a system for absorbing and thereby removing at least a portion of an acidic component from a process stream, said system comprising: an absorber adapted to accept a process stream, wherein said absorber employs an absorbent solution to absorb an acidic component from said process stream to produce a rich absorbent solution and a process stream having a reduced amount of said acidic component; a regenerator adapted to regenerate said rich absorbent solution, thereby producing a lean absorbent solution and a semi-lean absorbent solution; a solution outlet fluidly coupled to said regenerator to facilitate removal of at least a portion of said semi-lean absorbent solution from said regenerator; and a control mechanism coupled to said solution outlet, said control mechanism adapted to control an amount of said semi-lean absorbent solution removed from said regenerator.

According to other aspects illustrated herein, there is provided a method for increasing an amount of an acidic component removed from a process stream, said method comprising: contacting a process stream containing an acidic component with an absorbent solution and removing at least a portion of said acidic component from said process gas, thereby forming a rich absorbent solution, wherein said contact occurs in an absorber; regenerating said rich absorbent solution in a regenerator, wherein said rich absorbent solution is regenerated by contacting said rich absorbent solution with steam, thereby forming a semi-lean absorbent solution and a lean absorbent solution; removing an amount of semi-lean absorbent solution from said regenerator, wherein said amount of semi-lean absorbent solution removed from said regenerator is between about 20% to about 100% based on the total amount of absorbent solution in said regenerator; and introducing said semi-lean absorbent solution to said absorber, thereby increasing an amount of said acidic gas component removed from said process gas.

According to other aspects illustrated herein, there is provided a method for removing carbon dioxide from a process stream, said method including contacting said process stream with an absorbent solution to remove said carbon dioxide from said process stream and thereby forming a rich absorbent solution, regenerating said rich absorbent solution in a regenerator by contacting said rich absorbent solution with steam, the improvement comprising: forming a semi-lean absorbent solution and a lean absorbent solution during regeneration of said rich absorbent solution while maintaining a fixed level of energy utilized by a reboiler used to produce said steam; and removing an amount of said semi-lean absorbent solution from said regenerator, wherein said amount of said semi-lean absorbent solution removed from said regenerator is between about 20% to about 100% based on the total amount of absorbent solution in said regenerator.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 is a diagram depicting an example of one embodiment of a system for absorbing and thereby removing an acidic component from a process stream;

FIG. 2 is a diagram depicting an example of another embodiment of a system for absorbing and thereby removing an acidic component from a process stream;

FIG. 3 is illustrative of a process for removing an acidic component from a process stream; and

FIG. 4 is a graph showing a relationship between the amount of energy utilized by a reboiler and an amount of semi-lean absorbent material removed from a regenerator.

### DETAILED DESCRIPTION

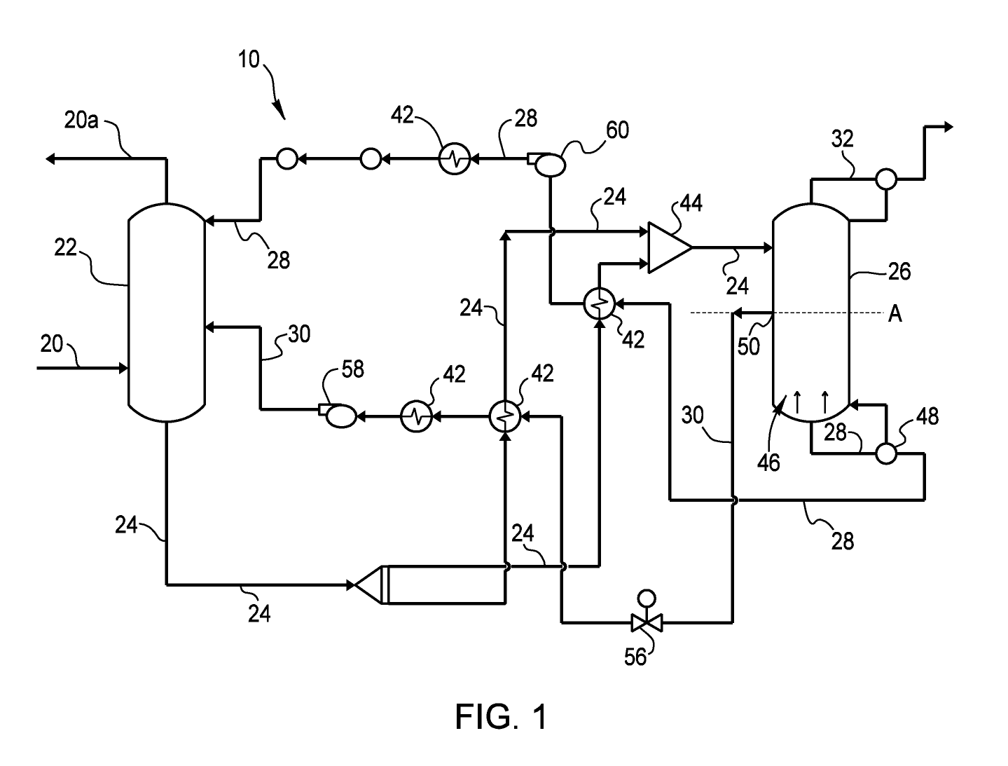

FIG. 1 illustrates a system 10 for absorbing and thereby removing at least a portion of an acidic component from a process stream 20. Process stream 20 may be any liquid stream or gas stream such as natural gas streams, synthesis gas streams, refinery gas or vapor streams, petroleum reservoirs, or streams generated from combustion of materials such as coal, natural gas or other fuels. One example is a flue gas generated by combustion of a fuel, such as coal, in a combustion chamber of a fossil fuel fired boiler. Depending on the type of or source of the process stream, the acidic component(s) may be in gaseous, liquid or particulate form.

Process stream 20 typically contains several acidic components, including, but not limited to carbon dioxide. By the time process stream 20 enters absorber 22, the process stream may have undergone treatment to remove particulate matter (e.g., fly ash), as well as sulfur oxides (SOx) and nitrogen oxides (NOx). However, processes may vary from system to system and therefore, such treatments may occur after process stream 20 passes through absorber 22, or not at all.

In one embodiment, system 10 includes an absorber 22. Absorber 22 is adapted to accept process stream 20. Typically, and as shown in FIG. 1, process stream 20 enters absorber 22 via an input point in the lower portion of the absorber and travels through the absorber. However, it is contemplated that process stream 20 may enter absorber 22 at any location that permits absorption of an acidic component from the process stream.

After traveling through absorber 22, process stream 20 is released as a process stream having a reduced amount of acidic component, which is noted as stream 20a in FIG. 1. Stream 20a is either released to an environment, such as the atmosphere, or sent for further processing (not shown). As shown in FIG. 1, stream 20a is released from the top portion of absorber 22. However, it is contemplated that stream 20a may be released from absorber 22 at any location of the absorber. The location of release of stream 20a may vary from system to system.

Absorber 22 employs an absorbent solution (not shown) that facilitates the absorption and the removal of a gaseous component from process stream 20. The absorbent solution typically includes a chemical solvent and water, where the chemical solvent contains a nitrogen-based solvent, and in particular, primary, secondary and tertiary alkanolamines; primary and secondary amines; sterically hindered amines; and severely sterically hindered secondary aminoether alcohols. Examples of commonly used chemical solvents include, but are not limited to: monoethanolamine (MEA), diethanolamine (DEA), diisopropanolamine (DIPA), N-methylethanolamine, triethanolamine (TEA), N-methyldiethanolamine (MDEA), piperazine, N-methylpiperazine (MP), N-hydroxyethylpiperazine (HEP), 2-amino-2-methyl-1-propanol (AMP), 2-(2-aminoethoxy)ethanol (also called diethyleneglycolamine or DEGA), 2-(2-tert-butylaminopropoxy)ethanol, 2-(2-tert-butylaminoethoxy)ethanol (TBEE), 2-(2-tert-amylaminoethoxy)ethanol, 2-(2-isopropylaminopropoxy)ethanol, 2-(2-(1-methyl-1-ethylpropylamino)ethoxy)ethanol, and the like. The foregoing may be used individually or in combination, and with or without other co-solvents, additives such as anti-foam agents, buffers, metal salts and the like, as well as corrosion inhibitors. Examples of corrosion inhibitors include, but are not limited to heterocyclic ring compounds selected from the group consisting of thiomopholines, dithianes and thioxanes wherein the carbon members of the thiomopholines, dithianes and thioxanes each have independently H, C₁₋₈ alkyl, C₇₋₁₂ alkaryl, C₆₋₁₀ aryl and/or C₃₋₁₀ cycloalkyl group substituents; a thiourea-aminne-formaldehyde polymer and the polymer used in combination with a copper (II) salt; an anion containing vanadium in the plus 4 or 5 valence state; and other known corrosion inhibitors.

Typically, the absorbent solution present in absorber 22 is referred to as a “lean” absorbent solution and/or a “semi-lean” absorbent solution. Lean and semi-lean absorbent solutions are capable of absorbing the acidic component from process stream 20, i.e., the absorbent solutions are not fully saturated or at full absorption capacity.

Absorption of the acidic component from process stream 20 occurs by contact between the lean and/or semi-lean absorbent solution and the process stream. Contact between process stream 20 and the lean and/or semi-lean absorbent solution can occur in any manner in absorber 22. In one example, process stream 20 enters the lower portion of absorber 22 and travels up the length of the absorber while the lean and/or semi-lean absorbent solution enters the absorber at a location above where the process stream enters and flows in a countercurrent direction of the process stream.

Contact between process stream 20 and the lean and/or semi-lean absorbent solution produces a rich absorbent solution 24 from the lean or semi-lean absorbent solution and process stream 20a having a reduced amount of the acidic component. In one example, rich absorbent solution 24 falls to the lower portion of absorber 22, where it is removed for further processing, while the process stream having a reduced amount of acidic component travels up the length of the absorber and is released as stream 20a from the top portion of the absorber. After stream 20a is released from absorber 22, it is either subjected to further treatment processes or sent to a stack (not shown) for release to an environment.

System 10 also includes a regenerator 26. Regenerator 26 is adapted to regenerate rich absorbent solution 24, thereby producing a lean absorbent solution 28 and a semi-lean absorbent solution 30 as well as a stream of acidic component 32.

Rich absorbent solution 24 may proceed from absorber 22 through a treatment train prior to entering regenerator 26. The treatment train may include a flash dry absorber, a controller, a recycler and a divider (not shown). Alternatively, transfer of rich absorbent 24 from absorber 22 to regenerator 26 may be facilitated by a flow control valve (not shown). In another alternative, absorber 22 may be directly coupled to regenerator 26 and therefore rich absorbent solution 24 may be transferred directly from the absorber to the regenerator.

As shown in FIG. 1, rich absorbent solution 24 may proceed through at least one heat exchanger 42 prior to entering a mixer 44. It is contemplated that rich absorbent solution 24 may undergo more steps or processes shown in FIG. 1, or alternatively, the rich absorbent solution may undergo less steps or processes than shown in FIG. 1.

As shown in FIG. 1, rich absorbent solution 24 may enter regenerator 26 at a location in the upper portion of the regenerator. However, it is contemplated that rich absorbent solution 24 can enter regenerator 26 at any location that would facilitate the regeneration of the rich absorbent solution.

After entering regenerator 26, rich absorbent solution 24 is contacted with a countercurrent flow of steam 46 that is produced by a reboiler 48. Steam 46 regenerates rich absorbent solution 24, thereby forming lean absorbent solution 28 and semi-lean absorbent solution 30 as well as a stream of acidic component 32. At least a portion of either or both lean absorbent solution 28 and semi-lean absorbent solution 30 are transferred to absorber 22 for further absorption and removal of the acidic component from process stream 20.

The amount (or level) of energy utilized by reboiler 48 to generate steam 46 may vary depending on the amount of rich absorbent solution 24 to be regenerated. Alternatively, the amount of energy utilized by reboiler 48 may be maintained at a set or constant level regardless of the amount of rich absorbent solution 24 to be regenerated. Maintenance of a constant level of energy utilized by reboiler 48 may result in less energy consumed by the reboiler as well as system 10 in its entirety. The level of energy utilized by reboiler 48 may vary or be maintained anywhere between 0.3 million British thermal units per hour (MMbtu/hr) (about 315 million joule/hour) and 0.8 MMbtu/hr (about 844 million joule/hour). In one example, the level of energy utilized by reboiler 48 is maintained about 0.7 MMbtu/hr (about 740 million joule/hour). The level of energy at which reboiler 48 is maintained may vary from system to system.

Typically, semi-lean absorbent solution 30 is formed in regenerator 26 when only a portion of rich absorbent solution 24 has been regenerated, i.e., the rich absorbent solution is not fully regenerated. At least a portion of semi-lean absorbent solution 30 is removed from regenerator 26 by way of a solution outlet 50 that is fluidly coupled to the regenerator. As used herein, the term “fluidly coupled” means two or more devices are connected or attached, either directly or indirectly, to one another, in order to facilitate flow of a liquid or a gas between them.

Solution outlet 50 may simply be an opening in regenerator 26, or may be any type of side draw capable of allowing removal of at least a portion of semi-lean absorbent solution 30 from the regenerator. Solution outlet 50 may be positioned at any location in regenerator 26. As shown in FIG. 1, solution outlet 50 may be positioned at a mid-point A of regenerator 26. However, it is contemplated that solution outlet 50 may be positioned at any location that facilitates the removal of at least a portion of semi-lean solution 30 from regenerator 26.

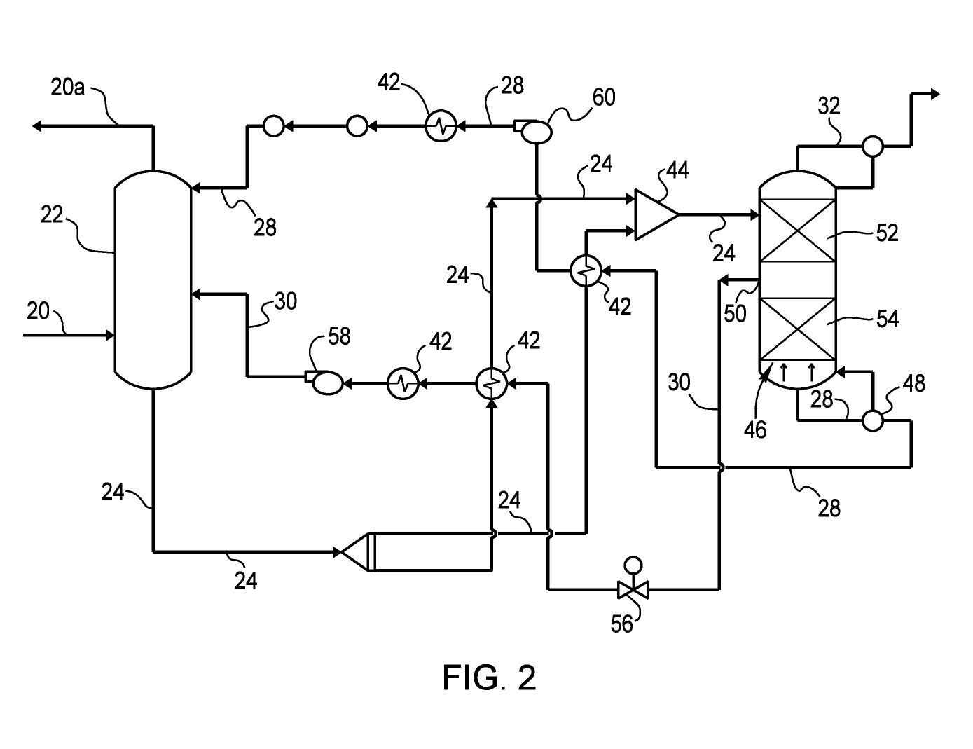

In one embodiment, as shown in FIG. 2, where like numerals indicate like parts as described in reference to FIG. 1, solution outlet 50 is positioned between a first regenerating section 52 and a second regenerating section 54 of regenerator 26. First regenerating section 52 regenerates a portion of rich absorbent solution 24 to form semi-lean absorbent solution 30. At least a portion of semi-lean absorbent solution 30 may either be removed from regenerator 26 or be further processed in second regenerating section 54, which regenerates the semi-lean absorbent solution to form lean absorbent solution 28.

It has been found that the amount of acidic component absorbed from process gas 20 in absorber 22 increases as the amount of semi-lean absorbent 30 is split, i.e., removed, from regenerator 26 is modified. Moreover, it has been found that maintaining a constant level of energy utilized by reboiler 48 results in more of the acidic component being removed from process stream 20 in absorber 22 as the amount of semi-lean absorbent solution 30 changes. Accordingly, in either embodiment shown in FIGS. 1 and 2, system 10 includes a control mechanism 56 coupled to solution outlet 50.

Control mechanism 56 is adapted to control an amount of semi-lean absorbent solution 30 split (hereinafter “removed”) from regenerator 26. Control mechanism 56 may be any mechanism that allows a user to control an amount of semi-lean absorbent solution 30 that is removed from regenerator 26. Examples of control mechanism 56 include, but are not limited to a valve, a pump, or the like, which may be coupled to a transducer, a control panel, a computer, or the like.

Control mechanism 56 allows a user to control and adjust an amount of semi-lean absorbent solution 30 removed from regenerator 26. The amount of semi-lean absorbent solution 30 removed from regenerator 26 varies from system to system and user to user. Typically, the amount of semi-lean absorbent solution 30 removed from regenerator 26 depends on the application of system 10, the needs of the user of system 10, as well as an amount of acidic component present in process stream 20. It is contemplated that in some applications of system 10, the amount of semi-lean absorbent solution 30 removed from regenerator 26 is maintained at a fixed amount while in other applications, the amount of the semi-lean absorbent solution removed from the regenerator varies or fluctuates depending on the needs of the system or the user.

In one embodiment, the amount of semi-lean absorbent solution 30 removed from regenerator 26 is between about 20% to about 100% based on a total amount of absorbent solution (total amount of absorbent solution includes rich absorbent solution, semi-lean absorbent solution and lean absorbent solution) in the regenerator. In another example, the amount of semi-lean absorbent solution 30 removed from regenerator 26 is between about 25% to about 90% based on a total amount of absorbent solution in the regenerator. In another example, the amount of semi-lean absorbent solution 30 removed from regenerator 26 is between about 30% to about 85% based on a total amount of absorbent solution in the regenerator. In another example, the amount of semi-lean absorbent solution 30 removed from regenerator 26 is between about 35% to about 80% based on a total amount of absorbent solution in the regenerator. In a further example, the amount of semi-lean absorbent solution 30 removed from regenerator 26 is between about 40% to about 80% based on a total amount of absorbent solution in the regenerator.

In yet another example, the amount of semi-lean absorbent solution 30 removed from regenerator 26 is between about 45% to about 80% based on a total amount of absorbent solution in the regenerator. In still a further example, the amount of semi-lean absorbent solution 30 removed from regenerator 26 is between about 50% to about 80% based on a total amount of absorbent solution in the regenerator. In another example, the amount of semi-lean absorbent solution 30 removed from regenerator 26 is between about 55% to about 80% based on a total amount of absorbent solution in the regenerator. In another example, the amount of semi-lean absorbent solution 30 removed from regenerator 26 is between about 60% to about 80% based on a total amount of absorbent solution in the regenerator.

In yet a further example, the amount of semi-lean absorbent solution 30 removed from regenerator 26 is between about 65% to about 80% based on a total amount of absorbent solution in the regenerator. In an even further example, the amount of semi-lean absorbent solution 30 removed from regenerator 26 is between about 70% to about 80% based on a total amount of absorbent solution in the regenerator. In even a further example, the amount of semi-lean absorbent solution 30 removed from regenerator 26 is between about 70% to about 75% based on a total amount of absorbent solution in the regenerator. In another example, the amount of semi-lean absorbent solution 30 removed from regenerator 26 is 70% based on a total amount of absorbent solution in the regenerator.

Semi-lean absorbent solution 30 is transferred to absorber 22 via a treatment train that may include at least one heat exchanger 42 and a pump 58. More or less components may be utilized to effect transfer of semi-lean absorbent solution 30 from control mechanism 56 to absorber 22. Semi-lean absorbent solution 30 may be introduced to absorber 22 at any location or position. As shown in FIGS. 1 and 2, semi-lean absorbent solution is introduced in the lower portion of absorber 22.

Lean absorbent solution 28 may be transferred to absorber 22 from regenerator 26 via a treatment train that may include at least one heat exchanger 42, a pump 60, as well as other control devices and/or monitors. More or less components may be utilized to effect transfer of lean absorbent solution 28 from regenerator 26 to absorber 22.

Lean absorbent solution 28 may be introduced to absorber 22 at any location or position. As shown in FIGS. 1 and 2, lean absorbent 28 is introduced in the upper portion of absorber 22.

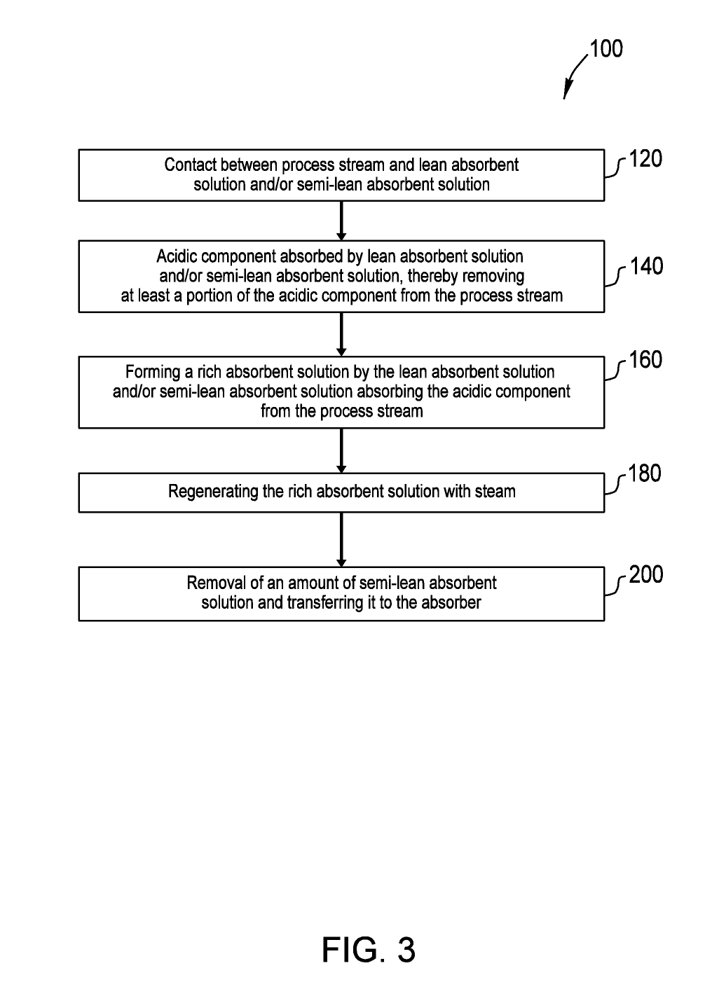

A method 100 of using system 10 to remove an acidic component from process stream 20 is shown in FIG. 3. In step 120, there is contact between an absorbent solution, such as a lean absorbent solution and/or a semi-lean absorbent solution, in absorber 22 and a process stream 20. An acidic component, such as carbon dioxide, present in process stream 20, is absorbed from the process stream by the lean absorbent solution and/or semi-lean absorbent solution, thereby removing at least a portion of said acidic component from the process stream in step 140. Rich absorbent solution 24 is formed in step 160 after the lean absorbent solution and/or the semi-lean absorbent solution absorbs the acidic component from process stream 20.

In step 180, rich absorbent solution 24 is regenerated in regenerator 26 by contacting the rich absorbent solution with steam 46, thereby forming a semi-lean absorbent solution 30 and a lean absorbent solution 28.

An amount of semi-lean absorbent solution 30 is removed from regenerator 26 and introduced to absorber 22 in step 200 of process 100. The removal of semi-lean absorbent solution 30 and transfer and introduction of the same into absorber 22 results in removal of the acidic gas component removed from process gas 20.

Utilization of semi-lean absorbent solution 30 in absorber 22 while maintaining a level of energy utilized by reboiler 48 may increase the amount or concentration of carbon dioxide removed from process stream 20. Maintenance of an energy level of reboiler 48 may result in the consumption of less energy in system 10.

Non-limiting examples of the system(s) and process(es) described herein are provided below. Unless otherwise noted, amounts are recited in percentage (%) removed from regenerator 26 based on the total flow of absorbent solution in the regenerator, energy utilized by reboiler 48 is given in MMbtu/hr, where MMbtu is equal to one million Btu (British thermal units) and “hr” is one hour.

### EXAMPLES

### Example 1A

### Variation of Reboiler Energy

A carbon dioxide removal system employing an absorber and a regenerator is modified to include a solution outlet in the regenerator for removing at least a portion of semi-lean absorbent solution from the regenerator. The solution outlet is coupled to a control mechanism, for example, a control valve, which controls the amount of semi-lean absorbent solution removed from the regenerator.

The control valve is set to a fixed amount of semi-lean absorbent solution removed from the regenerator (indicated as % split flow). In this instance, the fixed amount is 70% based on the total flow of absorbent solution in the regenerator.

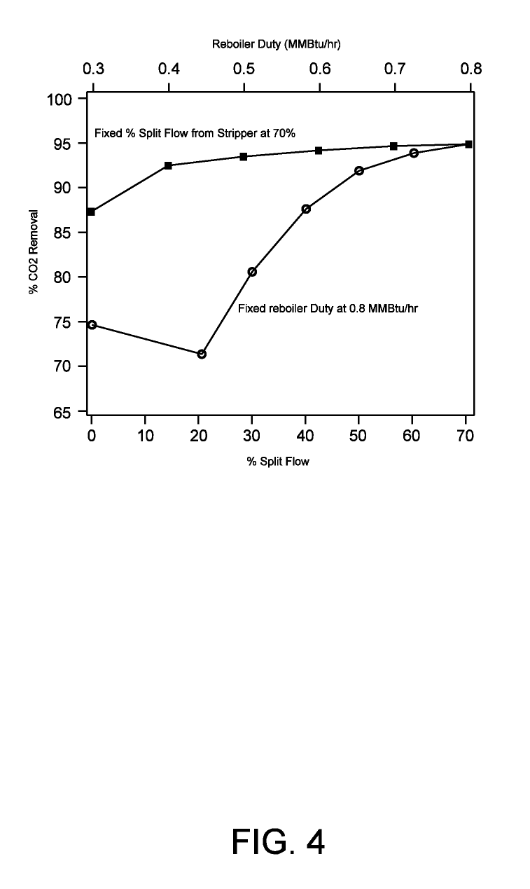

While the amount of semi-lean absorbent solution removed from the regenerator is maintained at a fixed amount, the amount of energy utilized by the reboiler increases from 0.3 MMbtu/hr (about 315 million joule/hour) to 0.8 MMbtu/hr (about 844 million joule/hour). As shown in FIG. 4, as an amount of energy utilized by the reboiler increases, the amount of carbon dioxide removed from a process stream in an absorber increases from about 87% to about 94% when the amount of semi-lean absorbent solution removed from the regenerator is maintained at 70%.

### Example 1B

### Variation of Amount of Semi-Lean Absorbent Solution Removed from a Regenerator

A carbon dioxide removal system employing an absorber and a regenerator is modified to include a solution outlet in the regenerator for removing at least a portion of semi-lean absorbent solution from the regenerator. The solution outlet is coupled to a control mechanism, for example, a control valve, which controls the amount of semi-lean absorbent solution removed from the regenerator. The control valve allows the amount of semi-lean absorbent solution removed from the regenerator (indicated as % split flow) to be increased or decreased.

The amount of energy utilized by a reboiler used to produce steam for the regenerator is set to a fixed amount. In this instance, the fixed amount of energy utilized by the reboiler is 0.8 MMbtu/hr (about 844 million joule/hour).

While the amount of energy utilized by the reboiler is maintained at a fixed amount, the amount semi-lean absorbent solution removed from the regenerator increases from 0% to about 70%. As shown in FIG. 4, as an amount of semi-lean absorbent removed from the regenerator increases, the amount of carbon dioxide removed from a process stream in an absorber increases from about 75% to about 94% when the amount of energy utilized by the reboiler is maintained at 08 MMbtu/hr (about 80 joule/hour).

Unless otherwise specified, all ranges disclosed herein are inclusive and combinable at the end points and all intermediate points therein. The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item. All numerals modified by “about” are inclusive of the precise numeric value unless otherwise specified.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for absorbing and thereby removing at least a portion of an acidic component from a process stream, said system comprising:
an absorber adapted to accept a process stream, wherein said absorber employs an absorbent solution to absorb an acidic component from said process stream to produce a rich absorbent solution and a process stream having a reduced amount of said acidic component;
a regenerator adapted to regenerate said rich absorbent solution, thereby producing a lean absorbent solution and a semi-lean absorbent solution;
a solution outlet fluidly coupled to said regenerator to facilitate removal of at least a portion of said semi-lean absorbent solution from said regenerator; and
a control mechanism coupled to said solution outlet, said control mechanism adapted to control an amount of said semi-lean absorbent solution removed from said regenerator.

2. A system according to claim 1, further comprising a reboiler adapted to produce a steam to regenerate said rich absorbent solution in said regenerator.

3. A system according to claim 2, wherein energy utilized to form said steam produced by said reboiler is maintained at a fixed level.

4. A system according to claim 1, wherein said acidic component is carbon dioxide.

5. A system according to claim 1, wherein said absorbent solution comprises a chemical solvent selected from the group of monoethanolamine (MEA), diethanolamine (DEA), diisopropanolamine (DIPA), N-methylethanolamine, triethanolamine (TEA), N-methyldiethanolamine (MDEA), piperazine, N-methylpiperazine (MP), N-hydroxyethylpiperazine (HEP), 2-amino-2-methyl-1-propanol (AMP), 2-(2-aminoethoxy)ethanol, 2-(2-tert-butylaminopropoxy)ethanol, 2-(2-tert-butylaminoethoxy)ethanol (TBEE), 2-(2-tert-amylaminoethoxy)ethanol, 2-(2-isopropylaminopropoxy)ethanol, or 2-(2-(1-methyl-1-ethylpropylamino)ethoxy)ethanol.

6. A system according to claim 3, wherein said absorbent solution comprises monoethanolamine.

7. A system according to claim 1, wherein said amount of semi-lean absorbent solution removed from said regenerator is between 20% and 100% based on a total amount of absorbent solution in said regenerator.

8. A system according to claim 7, wherein said amount of semi-lean absorbent solution removed from said regenerator is between 25% and 90% based on a total amount of absorbent solution in said regenerator.

9. A system according to claim 8, wherein said amount of semi-lean absorbent solution removed from said regenerator is 70% based on a total amount of absorbent solution in said regenerator.

10. A system according to claim 1, wherein said regenerator comprises at least a first regenerating section and a second regenerating section, said first regenerating section adapted to regenerate at least a portion of said rich absorbent solution to form said semi-lean absorbent solution and said second regenerating section adapted to regenerate at least a portion of said rich absorbent solution to form said lean absorbent solution; and
said solvent outlet is positioned between said first regenerating section and said second regenerating section to facilitate the removal of at least a portion of said semi-lean absorbent solution.

11. A system according to claim 1, wherein said process stream is a flue gas generated in a combustion chamber of a fossil fuel fired boiler.

12. A method for increasing an amount of an acidic component removed from a process stream, said method comprising:
contacting a process stream containing an acidic component with an absorbent solution and removing at least a portion of said acidic component from said process gas, thereby forming a rich absorbent solution, wherein said contact occurs in an absorber;
regenerating said rich absorbent solution in a regenerator, wherein said rich absorbent solution is regenerated by contacting said rich absorbent solution with steam, thereby forming a semi-lean absorbent solution and a lean absorbent solution;
removing an amount of semi-lean absorbent solution from said regenerator, wherein said amount of semi-lean absorbent solution removed from said regenerator is between about 20% to about 100% based on the total amount of absorbent solution in said regenerator; and
introducing said semi-lean absorbent solution to said absorber, thereby increasing an amount of said acidic gas component removed from said process gas.

13. A method according to claim 12, wherein said acidic component is carbon dioxide.

14. A method according to claim 12, wherein said absorbent solution comprises a chemical solvent selected from the group of monoethanolamine (MEA), diethanolamine (DEA), diisopropanolamine (DIPA), N-methylethanolamine, triethanolamine (TEA), N-methyldiethanolamine (MDEA), piperazine, N-methylpiperazine (MP), N-hydroxyethylpiperazine (HEP), 2-amino-2-methyl-1-propanol (AMP), 2-(2-aminoethoxy)ethanol, 2-(2-tert-butylaminopropoxy)ethanol, 2-(2-tert-butylaminoethoxy)ethanol (TBEE), 2-(2-tert-amylaminoethoxy)ethanol, 2-(2-isopropylaminopropoxy)ethanol, or 2-(2-(1-methyl-1-ethylpropylamino)ethoxy)ethanol.

15. A method according to claim 14, wherein said absorbent solution comprises monoethanolamine.

16. A method according to claim 12, wherein said amount of semi-lean absorbent solution removed from said regenerator is between 20% and 100% based on a total amount of absorbent solution in said regenerator.

17. A method according to claim 16, wherein said amount of semi-lean absorbent solution removed from said regenerator is between 25% and 90% based on a total amount of absorbent solution in said regenerator.

18. A method according to claim 17, wherein said amount of semi-lean absorbent solution removed from said regenerator is 70% based on a total amount of absorbent solution in said regenerator.

19. A method according to claim 12, wherein said steam is produced by a reboiler utilizing a fixed level of energy.

20. A method according to claim 12, wherein said regenerator comprises at least a first regenerating section and a second regenerating section, said first regenerating section adapted to regenerate at least a portion of said rich absorbent solution to form said semi-lean absorbent solution and said second regenerating section adapted to regenerate at least a portion of said rich absorbent solution to form said lean absorbent solution; and
positioning a solvent outlet between said first regenerating section and said second regenerating section to facilitate the removal of at least a portion of said semi-lean absorbent solution.

21. A method according to claim 12, wherein said process stream is a flue gas generated in a combustion chamber of a fossil fuel fired boiler

22. In a method for removing carbon dioxide from a process stream, said method including contacting said process stream with an absorbent solution to remove said carbon dioxide from said process stream and thereby forming a rich absorbent solution, regenerating said rich absorbent solution in a regenerator by contacting said rich absorbent solution with steam, the improvement comprising:
forming a semi-lean absorbent solution and a lean absorbent solution during regeneration of said rich absorbent solution while maintaining a fixed level of energy utilized by a reboiler used to produce said steam; and
removing an amount of said semi-lean absorbent solution from said regenerator, wherein said amount of said semi-lean absorbent solution removed from said regenerator is between about 20% to about 100% based on the total amount of absorbent solution in said regenerator.

23. A method according to claim 22, wherein said process stream is a flue gas generated in a combustion chamber of a fossil fuel fired boiler
